(19) United States
(12) Patent Application Publication
(10) Pub. No.: US 2016/0108227 A1
(43) Pub. Date: Apr. 21, 2016

(54) SUPERABSORBENT POLYMERS WITH RAPID ABSORPTION PROPERTIES AND PROCESS FOR PRODUCING SAME

(71) Applicant: EVONIK DEGUSSA GMBH, Essen (DE)

(72) Inventors: Laurent Wattebled, Düsseldorf (DE); Markus Henn, Gelsenkirchen (DE); Rainer Teni, Moers (DE)

(21) Appl. No.: 14/787,636

(22) PCT Filed: Apr. 29, 2014
(86) PCT No.: PCT/EP2014/058670

§ 371 Date: Oct. 28, 2015

(30) Foreign Application Priority Data
May 15, 2013 (DE) 10 2013 209 023.4

(51) Int. Cl. C08L 33/14; B01J 20/26

(52) U.S. Cl. CPC C08L 33/14; B01J 20/261

(57) ABSTRACT

The present invention relates to a water-absorbing polymer comprising the process steps of (i) mixing (α1) 0.1 to 99.999% by weight of polymerizable, ethylenically unsaturated monomers containing acid groups, or salts thereof, (α2) 0 to 70% by weight of polymerized, ethylenically unsaturated monomers copolymerizable with (α1), (α3) 0.001 to 10% by weight of one or more crosslinkers, (α4) water-soluble polymers, and (α5) one or more assistants, where the sum of the weights (α1) to (α5) is 100% by weight, (ii) free-radical polymerization with crosslinking to form a water-insoluble, aqueous untreated hydrogel polymer, (iii) drying the hydrogel polymer, (iv) grinding and sieving the water-absorbing polymer to size, (v) surface postcrosslinking the ground and sieved hydrogel polymer and (vi) drying and finishing the water-absorbing polymer, wherein 0.01 to 5% by weight of a blowing agent having a particle size of 10 μm to 900 μm are added, based on the hydrogel polymer.

The present invention relates to superabsorbent polymers with rapid absorption properties and to processes for production thereof.

The current trend in diaper construction is to produce even thinner constructions with reduced cellulose fiber content and increased superabsorbent content. The advantage of thinner constructions is exhibited not just in improved wear comfort but also in reduced costs in packaging and storage. With the trend toward ever thinner diaper constructions, the profile of requirements on the superabsorbents has changed significantly. Of crucial significance is now the ability of the hydrogel to conduct and distribute the liquid. Owing to the higher loading of the hygiene article (amount of superabsorbent per unit area), the polymer in the swollen state must not form a barrier layer for subsequent liquid (gel blocking). If the product has good transport properties, optimal exploitation of the overall hygiene article can be ensured.

In addition to the permeability of the superabsorbents (SAPs) (reported in the form of what is called the “Saline Flow Conductivity—SFC”) and the absorption capacity under compressive stress, the absorption rate of the superabsorbent particles in particular (reported in amount of liquid absorbed per gram of superabsorbent per second) is also a crucial criterion which enables statements about whether an absorbent core which comprises this superabsorbent in a large concentration and has only a low fluff content is capable, on its first contact with liquids, of absorbing them rapidly (called “acquisition”). In the case of absorbent cores with a high superabsorbent content, this “acquisition” depends, among other factors, on the absorption rate of the superabsorbent material.

From the prior art, there are various known property rights which are supposed to enable an increase in the absorption rate of superabsorbent particles. WO96/17884A1 discloses a water-absorbing resin for which a solid blowing agent with a particle diameter of 1 to 100 μm is used in the monomer solution. In principle, preference is given to organic azo compounds and here specifically to acrylic salts of azo compounds containing an amino group. Pure carbonates, ammonium nitride or mixtures thereof can optionally be used.

Disadvantages here are the rapid conversion of the azo compounds and the basic dispersion of the small solid particles in the monomer solution. Larger particles cannot be dispersed well without separation of particles and monomer solution in the dispersion before it reaches the gel point.

A disadvantage here in the case of use of superabsorbents known from the prior art is that leakage problems occur, since the SAP either absorbs the liquid too slowly and/or has unsuitable liquid transportation.

The current trend particularly in diaper construction is to produce even thinner absorbent cores with reduced cellulose fiber content and increased superabsorbent content. The advantage of thinner constructions is exhibited not just in improved wear comfort but also in reduced costs in packaging and storage. The newest generation of absorbent cores, which is described, for example, in WO-A-2008/155722, WO-A-2008/155711, WO-A-2008/155710, WO-A-2008/155702, WO-A-2008/155701, WO-A-2008/155699, EP-A-1 225 857, WO-A-01/15647, WO-A-2011/120504, DE-A-10 2009 049 450, WO-A-2008/117109, WO-A-97/11659, EP-A-0 826 349, WO-A-98/37846, WO-A-95/11653, WO-A-95/11651, WO-A-95/11652, WO-A-95/11654, WO-A-2004/071363 or WO-A-01/89439, is essentially cellulose-free (which is why corresponding diapers are also referred to as “fluffless diapers”). The immobilization of the superabsorbent particles, which in cellulose-containing absorbent cores is effected by the cellulose fibers, can be achieved in this newest generation of absorbent cores by, for example, immobilizing the superabsorbent particles on a substrate surface by means of thermoplastic fibers.

With the trend toward ever thinner diaper constructions and the omission of the temporary liquid storage and conduction function of the cellulose fibers, the profile of requirements on the superabsorbents has changed significantly. A factor of crucial importance is now the ability of the hydrogel to prevent the leakage of urine directly on micturition. This is achieved by the property of the superabsorbent/hydrogel of effectively absorbing the liquid during swelling and distributing it in the gel layer, with simultaneous minimization of the amount of unbound urine in the diaper. Due to good transport properties, advantageous superabsorbents also lead to optimal exploitation of the overall hygiene article.

U.S. Pat. No. 5,154,713 discloses water-absorbing polymers which are prepared by means of a carbonate blowing agent in the monomer solution. The carbonate particles are introduced here into the monomer solution well before the actual polymerization, and the initiator is added from 5 to 15 minutes after the dispersion of the carbonate blowing agent, as a result of which homogeneous distribution of these carbonate particles is not ensured and a not inconsiderable portion of the carbonate may be discharged again.

EP0644207 discloses superabsorbent polymers which are likewise admixed with an organic carbonate blowing agent in the monomer solution. Disadvantages here are the use of amine compounds, and also the elimination products of the organic carbonates remaining in the superabsorbent.

WO 2010/095427 discloses water-absorbing polymers in which a gas is dispersed into the monomer solution. This gas is nitrogen, argon, helium, carbon dioxide or the like, which is intended to ensure a more porous structure. The intention is to maintain these microbubbles in the monomer solution by means of polyoxyethylene-(20) sorbitan monostearate until the polymerization sets in. A disadvantage here is that the surfactants can be washed out of the end product again and adversely affect performance.

A factor of crucial importance is now the ability of the hydrogel to prevent the leakage of urine directly on micturition. This is achieved by the property of the superabsorbent/hydrogel of effectively absorbing the liquid during swelling and distributing it in the gel layer, with simultaneous minimization of the amount of unbound urine in the diaper. Due to good transport properties, advantageous superabsorbents also lead to optimal exploitation of the overall hygiene article.

The term “rewet” is generally understood to mean the property of a superabsorbent or of a composite comprising a superabsorbent to release liquid to an absorptive ply under compressive stress. The term “absorptive ply” is understood to mean, for example, paper, filter paper, collagen, sponges, foams or the like.

EP1858998B1 discloses superabsorbent foams where the monomer solution gives rise to a foam only under an elevated pressure of 12 bar by addition of carbon dioxide and surfactants.

However, the superabsorbents known to date from the prior art are only of inadequate suitability for use in the above-described new generation of cellulose-free diaper constructions.

In general, it is an object of the present invention to overcome the disadvantages arising from the prior art.

More particularly, it is an object of the present invention to provide a process for producing a water-absorbing polymer which has an improved swell rate and faster absorption of liquids, while simultaneously maintaining the overall quality, and more particularly a high permeability.

It is also a further object to perform the process in an economically simple manner, the intention being to minimize the use of organic additives, and also that a mode of operation at ambient pressure is to be provided.

It is a particular object of the present invention to provide a process by which water-absorbing polymers can be produced, and a particularly high swell rate can be ensured.

It is a further object of the present invention, in addition, to provide a process by which it is possible to produce water-absorbing polymers which ensure rapid and active liquid transportation, for example in thin diapers, such that rapid absorption and good distribution, i.e. corresponding capillarity, are ensured.

It is a further object of the invention, in particular, to specify a water-absorbing polymer, composites comprising such water-absorbing polymers, and chemical products comprising such water-absorbing polymers or composites, the water-absorbing polymers having an increased absorption capacity for aqueous solutions.

These objects are achieved by the subject-matter of the category-forming claims. Advantageous configurations and developments which can occur individually or in combination form the subject-matter of the dependent claims in each case.

A contribution to the achievement of the object stated at the outset is made by the process for producing a water-absorbing polymer, comprising the process steps of
(i) mixing
   (α1) 0.1 to 99.999% by weight, preferably 20 to 98.99% by weight and more preferably 30 to 98.95% by weight of polymerizable, ethylenically unsaturated monomers containing acid groups, or salts thereof, or polymerizable, ethylenically unsaturated monomers including a protonated or quaternized nitrogen, or mixtures thereof, particular preference being given to mixtures including at least ethylenically unsaturated monomers containing acid groups, preferably acrylic acid,
   (α2) 0 to 70% by weight, preferably 1 to 60% by weight and more preferably 1 to 40% by weight of polymerizable, ethylenically unsaturated monomers copolymerizable with (α1),
   (α3) 0.001 to 10% by weight, preferably 0.01 to 7% by weight and more preferably 0.05 to 5% by weight of one or more crosslinkers,
   (α4) 0 to 30% by weight, preferably 1 to 20% by weight and more preferably 5 to 10% by weight of water-soluble polymers,
   (α5) 0 to 20% by weight, preferably 0.01 to 7% by weight and more preferably 0.05 to 5% by weight of one or more assistants, where the sum of the weights of (α1) to (α5) 100% by weight,
(ii) free-radical polymerization with crosslinking to form a water-insoluble, aqueous untreated hydrogel polymer,
(iii) drying the hydrogel polymer,
(iv) grinding and sieving the hydrogel polymer to size,
(v) surface postcrosslinking the ground and sieved hydrogel polymer and
(vi) drying and finishing the water-absorbing polymer,
   wherein
   the aqueous monomer solution, prior to the addition of the initiator and the commencement of free-radical polymerization, is admixed with 0.01 to 5% by weight, preferably 0.02 to 2% by weight and more preferably 0.07 to 1% by weight of a blowing agent having a particle size of 10 nm to 900 nm, based on the hydrogel polymer, optionally 0.01 to 5% by weight, preferably 0.02 to 2% by weight and more preferably 0.07 to 1% by weight of at least one surfactant from the group of the nonionic, ionic or amphoteric surfactants, and, in steps (ii) to (iv) or before step (v), additionally with at least one acidic compound is added.

The term “water-absorbing polymer” is understood in accordance with the invention to mean the superabsorbent.

This inventive hydrogel polymer can be converted by means of thermally induced postcrosslinking to an inventive water-absorbing polymer (superabsorbent).

In the process, preferably in step (iii) or before step (v), at least one acidic compound from the group of acetic anhydride, maleic anhydride, fumaric anhydride, benzoic acid, formic acid, valeric acid, citric acid, glyoxylic acid, glycolic acid, glycerophosphoric acid, glutaric acid, chloroacetic acid, chloropropionic acid, cinnamic acid, succinic acid, acetic acid, tartaric acid, lactic acid, pyruvic acid, fumaric acid, propionic acid, 3-hydroxypropionic acid, malonic acid, butyric acid, isobutyric acid, imidinoacetic acid, malic acid, isethionic acid, methylmaleic acid, adipic acid, itaconic acid, crotonic acid, oxalic acid, salicylic acid, gluconic acid, gallic acid, sorbic acid, gluconic acid and p-hydroxybenzoic acid, tartaric acid, acid anhydrides, for instance P₂O₅, SO₂, N₂O, H₂SO₄ or HCl, mixtures of these or salts thereof is added.

Organic acidic compounds used are preferably acetic anhydride, maleic anhydride, fumaric anhydride, benzoic acid, formic acid, valeric acid, citric acid, glyoxylic acid, glycolic acid, glycerophosphoric acid, glutaric acid, chloroacetic acid, chloropropionic acid, cinnamic acid, succinic acid, acetic acid, tartaric acid, lactic acid, pyruvic acid, fumaric acid, oxalic acid, and more preferably citric acid, tartaric acid and oxalic acid.

Inorganic acids or acid anhydrides added, preferably in step (ii) and (iv), are those from the group of P₂O₅, SO₂, N₂O, H₂SO₄ and HCl.

The salts added are preferably those from the group of sulphuric acid, phosphoric acid and citric acid, alone or in mixtures with the other salts or organic acids.

Advantageously we, through the use of the acidic compound, preferably in the process step of postcrosslinking, a surprising improvement in the FSR value achieved, which leads to an increase in the absorption rate. It has likewise been found that, advantageously, the increase in the absorption rate is also enabled without addition of the surfactant.

The blowing agents used may be all carbonates from the group of lithium carbonate, sodium carbonate, potassium carbonate, rubidium carbonate, caesium carbonate, or higher-valency metal ions such as beryllium carbonate, calcium carbonate, magnesium carbonate, strontium carbonate or mixtures thereof. Further compounds used may also be granulated carbonates, which are also produced as mixed salts of a carbonate and/or percarbonate with a further salt which functions as an outer layer, for example a sulphate compound. According to the invention, the blowing agents have a particle size of 10 μm to 900 μm, preferably 50 μm to 500 μm and more preferably 100 μm to 450 μm.

Tailored surfactants are added to the monomer solution for the production of the inventive superabsorbents. These specific surfactants contain functional groups which are polymerizable. According to the invention, these are unsaturated polyether copolymers formed from comparatively hydrophilic ethylene glycol units and comparatively hydrophobic alkylene glycol units having 3 to 6 carbon atoms. The unsaturated polyethers may comprise, in combination with ethylene glycol units, one or more different alkylene glycol units. Preference is given to propylene glycol (e.g. 1,2- or 1,3-propanediol), butylene glycol (e.g. 1,2-, 1,3- or 1,4-butanediol), pentylene glycol (e.g. 1,5-pentanediol, 1,2-pentanediol, 1,3-pentanediol, 1,4-pentanediol, 2,3-pentanediol, 2,4-pentanediol 2,5-pentanediol) or hexylene glycol (e.g. 1,6-hexanediol). The alkylene glycol units may be distributed randomly, in blocks or as a gradient in the surfactant. In the context of the present invention, the individual alkylene glycol units may be isotactic, syndiotactic or atactic sequences of the configuration in the molecule.

The degree of polymerization of the polyether structure in the surfactant is generally within the range from 2 to 100, preferably within the range from 4 to 50, more preferably within the range from 6 to 20. The stated degrees of alkoxylation each relate to the mean degree of alkoxylation. Of course, the preparation generally results in mixtures in which lower and higher oligomers may additionally be present.

The unsaturated group may be a vinyl ether, (meth)allyl ether, 4-vinylbenzyl ether, (meth)acrylamide, methacrylic ester or acrylic ester group and is preferably at the end of the chain.

Usable polymerizable surfactants are also esters of polyether copolymers and ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene and maleic anhydride.

In addition, it is possible esters of polyether copolymers and allylsulphonic acid or aliphatic or aromatic vinylsulphonic acids or acrylic or methacrylic sulphonic acids, in which case examples of aliphatic or aromatic vinylsulphonic acids used are vinylsulphonic acid, 4-vinylbenzylsulphonic acid, vinyltoluenesulphonic acid or styrenesulphonic acid, acryloyl- or methacryloylsulphonic acids from the group of sulphoethyl (meth)acrylate, sulphopropyl (meth)acrylate, 2-hydroxy-3-methacryloyloxypropylsulphonic acid, (meth)acrylamidoalkylsulphonic acids from the group of 2-acrylamido-2-methylpropanesulphonic acid, phosphonic acid monomers from the group of vinylphosphonic acid, allylphosphonic acid, vinylbenzylphosphonic acid, (meth)acrylamidoalkylphosphonic acids, acrylamidoalkyldiphosphonic acids, phosphonomethylated vinylamines and (meth)acryloylphosphonic acid derivatives, or acrylamides and methacrylamides from the group of alkyl-substituted (meth)acrylamides or aminoalkyl-substituted derivatives of (meth)acrylamide from the group of N-methylol(meth)acrylamide, vinylamides from the group of N-vinylamides, N-vinylformamides, N-vinylacetamides, N-vinyl-N-methylacetamides, N-vinyl-N-methylformamides.

At the other end of the polyether chains is a hydroxyl group, a hydroxyl group etherified with an organyl radical R—, or the hydroxyl group esterified with an acyl radical of the general structure R—(C═O)—. Where the organyl radical R— is a C₁- to C₁₀-alkyl group or a C₆- to C₁₀-alkylaryl group and may be linear or branched. Preference is given to hydroxyl group, etherified hydroxyl group with methyl, ethyl, n-propyl, isopropyl, n-butyl, isobutyl, n-pentyl, 2-methylbutyl, 2,2-dimethylpropyl, and also n-hexyl, n-heptyl, n-octyl, n-nonyl, n-decyl or the isomers of these compounds as alkyl radicals.

Particular preference is given to surfactants of the following formula:

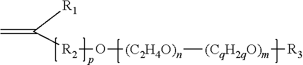

in which the alkylene glycol units (C₂H₄O) and (C_{q}H_{2q}O) may be distributed randomly, in blocks or as a gradient and
R₁ is —H or —CH₃
R₂ is a —C═O— group or an alkylene group from the group of methylene and ethylene,
R₃ is —H, linear or branched C₁- to C₉-alkyl or C₆- to C₉-alkylaryl,
p=0 or 1,
q is a number from 3 to 4 and
n and m are each a number from 1 to 20.

Particular preference is given to random or gradient structures, for example hydroxy-functional surfactants such as Blemmer®50PEP-300 (polyalkylene glycol monomethacrylates; 3.5 ethylene glycol units and 2.5 propylene glycol units), and Blemmer®55PET-800 (polyalkylene glycol monomethacrylates; 10 ethylene glycol units and 5 butylene glycol units).

In a further preferred embodiment, block structures are, for example Blemmer®70PEP-350B (polyalkylene glycol monomethacrylates; 5 ethylene glycol units and 2 terminal propylene glycol units), all from NOF Corporation (Japan) and PE 7316/02 (polyalkylene glycol monoallyl ether, (6 ethylene glycol units and 6 terminal propylene glycol units) Evonik Industries AG).

In addition, for the block copolymers, examples of polymerizable surfactants having an alkyl ether radical are enumerated as follows: methoxy polyalkylene glycol mono(meth)acrylates (6 ethylene glycol units and 6 terminal propylene glycol units; both as 7.5 ethylene glycol units and 3 terminal propylene glycol units) and butoxy polyalkylene glycol mono(meth)acrylates (4 propylene glycol units and 7 terminal ethylene glycol units) from Evonik Industries AG.

In a further embodiment, the allylic surfactants may also be present in a random structure, for example polyalkylene glycol monoallyl ether (7 ethylene glycol units and 3 propylene glycol units) (PE8482 Evonik Industries AG) and Pluriol® A23R (BASF).

Advantageously, the surfactants are generally used simultaneously with the crosslinker. In one embodiment, the blowing agent is added after the addition of the surfactant. In further embodiments, the blowing agent can be supplied at the same time as or before the surfactant.

On addition of blowing agents or sodium carbonate, small bubbles form, these having a smaller diameter in the presence of surfactants.

Advantageously, the surfactants stabilize the large gas surface area which arises in the solution through the blowing agent. The polymerization which proceeds in parallel fixes a fine porous structure (porous gel). The surfactants are “inactivated” during the polymerization, which means that they can be incorporated in the polymer network or are incorporated due to their reactive functionality.

The monoethylenically unsaturated monomers (α1) containing acid groups may be partly or fully neutralized, preferably partly. The monoethylenically unsaturated monomers containing acid groups have preferably been neutralized to an extent of at least 10 mol %, more preferably to an extent of at least 25 to 50 mol % and further preferably to an extent of 50-90 mol %. The neutralization of the monomers (α1) may precede or else follow the polymerization. In this case, the partial neutralization is effected to an extent of at least 10 mol %, more preferably to an extent of at least 25 to 90 mol % and further preferably to an extent of 50-80 mol %. Moreover, neutralization can be effected with alkali metal hydroxides, alkaline earth metal hydroxides, ammonia, and carbonates and bicarbonates. In addition, any further base which forms a water-soluble salt with the acid is conceivable. Mixed neutralization with different bases is also conceivable. Preference is given to neutralization with ammonia or with alkali metal hydroxides, more preferably with sodium hydroxide or with ammonia.

In addition, the free acid groups in a polymer may predominate, such that this polymer has a pH within the acidic range. This acidic water-absorbing polymer may be at least partly neutralized by a polymer with free basic groups, preferably amine groups, which is basic compared to the acid polymer. These polymers are referred to in the literature as “Mixed-Bed Ion-Exchange Absorbent Polymers” (MBIEA polymers) and are disclosed in WO 99/34843 inter alia. The disclosure of WO 99/34843 is hereby incorporated by reference and is thus considered to form part of the disclosure. In general, MBIEA polymers constitute a composition which includes firstly basic polymers capable of exchanging anions, and secondly a polymer which is acidic compared to the basic polymer and is capable of exchanging cations. The basic polymer has basic groups and is typically obtained by the polymerization of monomers which bear basic groups or groups which can be converted to basic groups. These monomers are in particular those which have primary, secondary or tertiary amines or the corresponding phosphines, or at least two of the above functional groups. This group of monomers includes especially ethyleneamine, allylamine, diallylamine, 4-aminobutene, alkyloxycyclines, vinylformamide, 5-aminopentene, carbodiimide, formaldacine, melamine and the like, and the secondary or tertiary amine derivatives thereof.

Preferred monoethylenically unsaturated monomers (α1) containing acid groups are acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene and maleic anhydride, preference being given particularly to acrylic acid and methacrylic acid and additionally to acrylic acid.

In addition to these monomers containing carboxylate groups, preferred monoethylenically unsaturated monomers (α1) containing acid groups additionally include ethylenically unsaturated sulphonic acid monomers or ethylenically unsaturated phosphonic acid monomers.

Preferred ethylenically unsaturated sulphonic acid monomers are allylsulphonic acid or aliphatic or aromatic vinylsulphonic acids or acrylic or methacrylic sulphonic acids. Preferred aliphatic or aromatic vinylsulphonic acids are vinylsulphonic acid, 4-vinylbenzylsulphonic acid, vinyltoluenesulphonic acid and styrenesulphonic acid. Preferred acryloyl- or methacryloylsulphonic acids are sulphoethyl (meth)acrylate, sulphopropyl (meth)acrylate, 2-hydroxy-3-methacryloyloxypropylsulphonic acid, and (meth)acrylamidoalkylsulphonic acids such as 2-acrylamido-2-methylpropanesulphonic acid.

Preferred ethylenically unsaturated phosphonic acid monomers are vinylphosphonic acid, allylphosphonic acid, vinylbenzylphosphonic acid, (meth)acrylamidoalkylphosphonic acids, acrylamidoalkyldiphosphonic acids, phosphonomethylated vinylamines and (meth)acryloylphosphonic acid derivatives.

Preferred ethylenically unsaturated monomers (α1) containing a protonated nitrogen are preferably dialkylaminoalkyl (meth)acrylates in protonated form, for example dimethylaminoethyl (meth)acrylate hydrochloride or dimethylaminoethyl (meth)acrylate hydrosulphate, and dialkylaminoalkyl(meth)acrylamides in protonated form, for example dimethylaminoethyl(meth)acrylamide hydrochloride, dimethylaminopropyl(meth)acrylamide hydrochloride, dimethylaminopropyl(meth)acrylamide hydrosulphate or dimethylaminoethyl(meth)acrylamide hydrosulphate.

Preferred ethylenically unsaturated monomers (α1) containing a quaternized nitrogen are dialkylammonioalkyl (meth)acrylates in quaternized form, for example trimethylammonioethyl (meth)acrylate methosulphate or dimethylethylammonioethyl (meth)acrylate ethosulphate, and (meth)acrylamidoalkyldialkylamines in quaternized form, for example (meth)acrylamidopropyltrimethylammonium chloride, trimethylammonioethyl (meth)acrylate chloride or (meth)acrylamidopropyltrimethylammonium sulphate.

Preferred monoethylenically unsaturated monomers (α2) copolymerizable with (α1) are acrylamides and methacrylamides.

Preferred (meth)acrylamides are, in addition to acrylamide and methacrylamide, alkyl-substituted (meth)acrylamides or aminoalkyl-substituted derivatives of (meth)acrylamide, such as N-methylol(meth)acrylamide, N,N-dimethylamino(meth)acrylamide, dimethyl(meth)acrylamide or diethyl(meth)acrylamide. Possible vinylamides are, for example, N-vinylamides, N-vinylformamides, N-vinylacetamides, N-vinyl-N-methylacetamides, N-vinyl-N-methylformamides, vinylpyrrolidone. Among these monomers, particular preference is given to acrylamide.

Additionally preferred as monoethylenically unsaturated monomers (α2) copolymerizable with (α1) are water-dispersible monomers. Preferred water-dispersible monomers are acrylic esters and methacrylic esters, such as methyl (meth)acrylate, ethyl (meth)acrylate, propyl (meth)acrylate or butyl (meth)acrylate, and also vinyl acetate, styrene and isobutylene. Crosslinkers (α3) preferred in accordance with the invention are compounds having at least two ethylenically unsaturated groups within one molecule (crosslinker class I), compounds having at least two functional groups which can react with functional groups of monomers (α1) or (α2) in a condensation reaction (=condensation crosslinkers), in an addition reaction or in a ring-opening reaction (crosslinker class II), compounds which have at least one ethylenically unsaturated group and at least one functional group which can react with functional groups of monomers (α1) or (α2) in a condensation reaction, in an addition reaction or in a ring-opening reaction (crosslinker class III), or polyvalent metal cations (crosslinker class IV). The compounds of crosslinker class I achieve crosslinking of the polymers through the free-radical polymerization of the ethylenically unsaturated groups of the crosslinker molecule with the monoethylenically unsaturated monomers (α1) or (α2), while the compounds of the crosslinker class II and the polyvalent metal cations of crosslinker class IV achieve crosslinking of the polymers by a condensation reaction of the functional groups (crosslinker class II) or by electrostatic interaction of the polyvalent metal cation (crosslinker class IV) with the functional groups of monomers (α1) or (α2). In the case of the compounds of crosslinker class III, there is correspondingly crosslinking of the polymer both by free-radical polymerization of the ethylenically unsaturated group and by a condensation reaction between the functional group of the crosslinker and the functional groups of monomers (α1) or (α2).

Preferred compounds of crosslinker class I are poly(meth)acrylic esters which are obtained, for example, by the reaction of a polyol, for example ethylene glycol, propylene glycol, trimethylolpropane, 1,6-hexanediol, glycerol, pentaerythritol, polyethylene glycol or polypropylene glycol, of an amino alcohol, of a polyalkylenepolyamine, for example diethylenetriamine or triethylenetetramine, or of an alkoxylated polyol with acrylic acid or methacrylic acid. Preferred compounds of crosslinker class I are additionally polyvinyl compounds, poly(meth)allyl compounds, (meth)acrylic esters of a monovinyl compound or (meth)acrylic esters of a mono(meth)allyl compound, preferably of the mono(meth)allyl compounds of a polyol or of an amino alcohol. In this context, reference is made to DE 195 43 366 and DE 195 43 368. The disclosures are hereby incorporated by reference and are thus considered to form part of the disclosure.

Examples of compounds of crosslinker class I include alkenyl di(meth)acrylates, for example ethylene glycol di(meth)acrylate, 1,3-propylene glycol di(meth)acrylate, 1,4-butylene glycol di(meth)acrylate, 1,3-butylene glycol di(meth)acrylate, 1,6-hexanediol di(meth)acrylate, 1,10-decanediol di(meth)acrylate, 1,12-dodecanediol di(meth)acrylate, 1,18-octadecanediol di(meth)acrylate, cyclopentanediol di(meth)acrylate, neopentyl glycol di(meth)acrylate, methylene di(meth)acrylate or pentaerythritol di(meth)acrylate, alkenyldi(meth)acrylamides, for example N-methyldi(meth)acrylamide, N,N′-3-methylbutylidenebis(meth)acrylamide, N,N′-(1,2-dihydroxyethylene)bis(meth)acrylamide, N,N′-hexamethylenebis(meth)acrylacrylamide or N,N′-methylenebis(meth)acrylamide, polyalkoxy di(meth)acrylates, for example diethylene glycol di(meth)acrylate, triethylene glycol di(meth)acrylate, tetraethylene glycol di(meth)acrylate, dipropylene glycol di(meth)acrylate, tripropylene glycol di(meth)acrylate or tetrapropylene glycol di(meth)acrylate, bisphenol A di(meth)acrylate, ethoxylated bisphenol A di(meth)acrylate, benzylidene di(meth)acrylate, 1,3-di(meth)acryloyloxy-2-propanol, hydroquinone di(meth)acrylate, di(meth)acrylate esters of trimethylolpropane which has preferably been alkoxylated, preferably ethoxylated, with 1 to 30 mol of alkylene oxide per hydroxyl group, thioethylene glycol di(meth)acrylate, thiopropylene glycol di(meth)acrylate, thiopolyethylene glycol di(meth)acrylate, thiopolypropylene glycol di(meth)acrylate, divinyl ethers, for example 1,4-butanediol divinyl ether, divinyl esters, for example divinyl adipate, alkanedienes, for example butadiene or 1,6-hexadiene, divinylbenzene, di(meth)allyl compounds, for example di(meth)allyl phthalate or di(meth)allyl succinate, homo- and copolymers of di(meth)allyldimethylammonium chloride and homo- and copolymers of diethyl(meth)allylaminomethyl (meth)acrylate ammonium chloride, vinyl (meth)acryloyl compounds, for example vinyl (meth)acrylate, (meth)allyl (meth)acryloyl compounds, for example (meth)allyl (meth)acrylate, (meth)allyl (meth)acrylate ethoxylated with 1 to 30 mol of ethylene oxide per hydroxyl group, di(meth)allyl esters of polycarboxylic acids, for example di(meth)allyl maleate, di(meth)allyl fumarate, di(meth)allyl succinate or di(meth)allyl terephthalate, compounds having 3 or more ethylenically unsaturated, free-radically polymerizable groups, for example glyceryl tri(meth)acrylate, (meth)acrylate esters of glycerol which has been ethoxylated with preferably 1 to 30 mol of ethylene oxide per hydroxyl group, trimethylolpropane tri(meth)acrylate, tri(meth)acrylate esters of trimethylolpropane which has preferably been alkoxylated, preferably ethoxylated, with 1 to 30 mol of alkylene oxide per hydroxyl group, trimethacrylamide, (meth)allylidene di(meth)acrylate, 3-allyloxy-1,2-propanediol di(meth)acrylate, tri(meth)allyl cyanurate, tri(meth)allyl isocyanurate, pentaerythritol tetra(meth)acrylate, pentaerythritol tri(meth)acrylate, (meth)acrylic esters of pentaerythritol ethoxylated with preferably 1 to 30 mol of ethylene oxide per hydroxyl group, tris(2-hydroxyethyl) isocyanurate tri(meth)acrylate, trivinyl trimellitate, tri(meth)allylamine, di(meth)allylalkylamines, for example di(meth)allylmethylamine, tri(meth)allyl phosphate, tetra(meth)allylethylenediamine, poly(meth)allyl esters, tetra(meth)allyloxyethane or tetra(meth)allylammonium halides.

Preferred compounds of crosslinker class II are compounds which have at least two functional groups which can react in a condensation reaction (=condensation crosslinkers), in an addition reaction or in a ring-opening reaction with the functional groups of monomers (α1) or (α2), preferably with acid groups of monomers (α1). These functional groups of the compounds of crosslinker class II are preferably alcohol, amine, aldehyde, glycidyl, isocyanate, carbonate or epichloro functions.

Examples of compounds of crosslinker class II include polyols, for example ethylene glycol, polyethylene glycols such as diethylene glycol, triethylene glycol and tetraethylene glycol, propylene glycol, polypropylene glycols such as dipropylene glycol, tripropylene glycol or tetrapropylene glycol, 1,3-butanediol, 1,4-butanediol, 1,5-pentanediol, 2,4-pentanediol, 1,6-hexanediol, 2,5-hexanediol, glycerol, polyglycerol, trimethylolpropane, polyoxypropylene, oxyethylene-oxypropylene block copolymers, sorbitan fatty acid esters, polyoxyethylene sorbitan fatty acid esters, pentaerythritol, polyvinyl alcohol and sorbitol, amino alcohols, for example ethanolamine, diethanolamine, triethanolamine or propanolamine, polyamine compounds, for example ethylenediamine, diethylenetriamine, triethylenetetramine, tetraethylenepentamine or pentaethylenehexamine, polyglycidyl ether compounds such as ethylene glycol diglycidyl ether, polyethylene glycol diglycidyl ether, glyceryl diglycidyl ether, glyceryl polyglycidyl ether, pentaerythrityl polyglycidyl ether, propylene glycol diglycidyl ether, polypropylene glycol diglycidyl ether, neopentyl glycol diglycidyl ether, hexanediol glycidyl ether, trimethylolpropane polyglycidyl ether, sorbitol polyglycidyl ether, diglycidyl phthalate, adipic acid diglycidyl ether, 1,4-phenylenebis(2-oxazoline), glycidol, polyisocyanates, preferably diisocyanates such as toluene 2,4-diisocyanate and hexamethylene diisocyanate, polyaziridine compounds such as 2,2-bishydroxymethylbutanol tris[3-(1-aziridinyl)propionate], 1, 6-hexamethylenediethyleneurea and diphenylmethanebis-4,4′-N,N′-diethyleneurea, halogen peroxides, for example epichloro- and epibromohydrin and α-methylepichlorohydrin, alkylene carbonates such as 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one, polyquaternary amines such as condensation products of dimethylamines and epichlorohydrin. Preferred compounds of crosslinker class II are additionally polyoxazolines such as 1,2-ethylenebisoxazoline, crosslinkers with silane groups, such as γ-glycidoxypropyltrimethoxysilane and γ-aminopropyltrimethoxysilane, oxazolidinones such as 2-oxazolidinone, bis- and poly-2-oxazolidinones and diglycol silicates.

Preferred compounds of class III include hydroxyl- or amino-containing esters of (meth)acrylic acid, for example 2-hydroxyethyl (meth)acrylate and 2-hydroxypropyl (meth)acrylate, and also hydroxyl- or amino-containing (meth)acrylamides or mono(meth)allyl compounds of diols.

The polyvalent metal cations of crosslinker class IV derive preferably from mono- or polyvalent cations, the monovalent especially from alkali metals such as potassium, sodium, lithium, preference being given to lithium. Preferred divalent cations derive from zinc, beryllium, alkaline earth metals such as magnesium, calcium, strontium, preference being given to magnesium. Further higher-valency cations usable in accordance with the invention are cations of aluminium, iron, chromium, manganese, titanium, zirconium and other transition metals, and also double salts of such cations or mixtures of the salts mentioned. Preference is given to using aluminium salts and alums and the different hydrates thereof, for example AlCl₃×6H₂O, NaAl(SO₄)₂×12 H₂O, KA1(SO₄)₂×12 H₂O or Al₂(SO₄)₃×14-18 H₂O. Particular preference is given to using Al₂(SO₄)₃ and hydrates thereof as crosslinkers of crosslinking class IV.

The superabsorbent particles used in the process according to the invention are preferably crosslinked by crosslinkers of the following crosslinker classes, or by crosslinkers of the following combinations of crosslinker classes: I, II, III, IV, I II, I III, I IV, I II III, I II IV, I III IV, II III IV, II IV or III IV. The above combinations of crosslinker classes are each a preferred embodiment of crosslinkers of a superabsorbent particle used in the process according to the invention.

Further preferred embodiments of the superabsorbent particles used in the process according to the invention are polymers which are crosslinked by any of the aforementioned crosslinkers of crosslinker class I. Among these, preference is given to water-soluble crosslinkers. In this context, particular preference is given to N,N′-methylenebisacrylamide, polyethylene glycol di(meth)acrylates, triallylmethylammonium chloride, tetraallylammonium chloride, and allyl nonaethylene glycol acrylate prepared with 9 mol of ethylene oxide per mole of acrylic acid.

As water-soluble polymers (α4), the superabsorbent particles may comprise water-soluble polymers, such as partly or fully hydrolysed polyvinyl alcohol, polyvinylpyrrolidone, starch or starch derivatives, polyglycols or polyacrylic acid, preferably incorporated in polymerized form. The molecular weight of these polymers is uncritical provided that they are water-soluble. Preferred water-soluble polymers are starch or starch derivatives or polyvinyl alcohol. The water-soluble polymers, preferably synthetic water-soluble polymers such as polyvinyl alcohol, can also serve as a graft base for the monomers to be polymerized.

The assistants (α5) present in the polymers are organic or inorganic particles, for example odor binders, especially zeolites or cyclodextrins, skincare substances, surfactants or antioxidants.

The preferred organic assistants include cyclodextrins or derivatives thereof, and polysaccharides. Also preferred are cellulose and cellulose derivatives such as CMC, cellulose ethers. Preferred cyclodextrins or cyclodextrin derivatives are those compounds disclosed in DE-A-198 25 486 at page 3 line 51 to page 4 line 61. The aforementioned section of this published patent application is hereby incorporated by reference and is considered to form part of the disclosure of the present invention. Particularly preferred cyclodextrins are underivatized α-, β-, γ- or δ-cyclodextrins.

The inorganic particulate assistants used may be any materials which are typically used to modify the properties of water-absorbing polymers. The preferred inorganic assistants include sulphates such as Na₂SO₄, lactates, for instance sodium lactate, silicates, especially framework silicates such as zeolites, or silicates which have been obtained by drying aqueous silica solutions or silica sols, for example the commercially available products such as precipitated silicas and fumed silicas, for example Aerosils having a particle size in the range from 5 to 50 nm, preferably in the range from 8 to 20 nm, such as “Aerosil 200” from Evonik Industries AG, aluminates, titanium dioxides, zinc oxides, clay materials, and further minerals familiar to those skilled in the art, and also carbonaceous inorganic materials.

Preferred silicates are all natural or synthetic silicates which are disclosed as silicates in Hollemann and Wiberg, Lehrbuch der Anorganischen Chemie [Inorganic Chemistry], Walter de Gruyter-Verlag, 91st-100th edition, 1985, on pages 750 to 783. The aforementioned section of this textbook is hereby incorporated by reference and is considered to form part of the disclosure of the present invention.

Particularly preferred silicates are the zeolites. The zeolites used may be all synthetic or natural zeolites known to those skilled in the art. Preferred natural zeolites are zeolites from the natrolite group, the harmotone group, the mordenite group, the chabasite group, the faujasite group (sodalite group) or the analcite group. Examples of natural zeolites are analcime, leucite, pollucite, wairakite, bellbergite, bikitaite, boggsite, brewsterite, chabazite, willhendersonite, cowlesite, dachiardite, edingtonite, epistilbite, erionite, faujasite, ferrierite, amicite, garronite, gismondine, gobbinsite, gmelinite, gonnardite, goosecreekite, harmotone, phillipsite, wellsite, clinoptilolite, heulandite, laumontite, levyne, mazzite, merlinoite, montesommaite, mordenite, mesolite, natrolite, scolecite, offretite, paranatrolite, paulingite, perlialite, barrerite, stilbite, stellerite, thomsonite, tschernichite or yugawaralite. Preferred synthetic zeolites are zeolite A, zeolite X, zeolite Y, zeolite P, or the product ABSCENTS®.

The zeolites used may be zeolites of what is called the “intermediate” type, in which the SiO₂/AlO₂ ratio is less than 10; the SiO₂/AlO₂ ratio of these zeolites is more preferably within a range from 2 to 10. In addition to these “intermediate” zeolites, it is also possible to use zeolites of the “high” type, which include, for example, the known “molecular sieve” zeolites of the ZSM type, and β-zeolite. These “high” zeolites are preferably characterized by an SiO₂/AlO₂ ratio of at least 35, more preferably by an SiO₂/AlO₂ ratio within a range from 200 to 500.

The aluminates used are preferably the naturally occurring spinels, especially common spinel, zinc spinel, iron spinel or chromium spinel.

Preferred titanium dioxide is pure titanium dioxide in the rutile, anatase and brookite crystal forms, and also iron-containing titanium dioxides, for example ilmenite, calcium-containing titanium dioxides such as titanite or perovskite.

Preferred clay materials are those disclosed as clay materials in Hollemann and Wiberg, Lehrbuch der Anorganischen Chemie, Walter de Gruyter-Verlag, 91st-100th edition, 1985, on pages 783 to 785. Particularly the aforementioned section of this textbook is hereby incorporated by reference and is considered to form part of the disclosure of the present invention. Particularly preferred clay materials are kaolinite, illite, halloysite, montmorillonite and talc.

Further inorganic fines preferred in accordance with the invention are the metal salts of the mono-, oligo- and polyphosphoric acids. Among these, preference is given especially to the hydrates, particular preference being given to the mono- to decahydrates and trihydrates. Useful metals include especially alkali metals and alkaline earth metals, preference being given to the alkaline earth metals. Among these, Mg and Ca are preferred and Mg is particularly preferred. In the context of phosphates, phosphoric acids and metal compounds thereof, reference is made to Hollemann and Wiberg, Lehrbuch der Anorganischen Chemie, Walter de Gruyter-Verlag, 91st-100th edition, 1985, on pages 651 to 669. The aforementioned section of this textbook is hereby incorporated by reference and is considered to form part of the disclosure of the present invention.

Preferred carbonaceous but nonorganic assistants are those pure carbons which are mentioned as graphites in Hollemann and Wiberg, Lehrbuch der Anorganischen Chemie, Walter de Gruyter-Verlag, 91st-100th edition, 1985, on pages 705 to 708. The aforementioned section of this textbook is hereby incorporated by reference and is considered to form part of the disclosure of the present invention. Particularly preferred graphites are synthetic graphites, for example coke, pyrographite, activated carbon or carbon black.

The water-absorbing polymers obtained in the process according to the invention are preferably obtainable by first preparing a hydrogel polymer (PC) in particulate form from the aforementioned monomers and crosslinkers. This starting material for the water-absorbing polymers is produced, for example, by bulk polymerization which is preferably effected in kneading reactors such as extruders, solution polymerization, spray polymerization, inverse emulsion polymerization or inverse suspension polymerization. Preference is given to performing the solution polymerization in water as a solvent. The solution polymerization can be effected continuously or batchwise. The prior art discloses a wide spectrum of possible variations with regard to reaction conditions, such as temperatures, type and amount of the initiators, and of the reaction solution. Typical processes are described in the following patents: U.S. Pat. No. 4,286,082, DE 27 06 135, U.S. Pat. No. 4,076,663, DE 35 03 458, DE 40 20 780, DE 42 44 548, DE 43 23 001, DE 43 33 056, DE 44 18 818. The disclosures are hereby incorporated by reference and are thus considered to form part of the disclosure.

The initiators used to initiate the polymerization may be all initiators which form free radicals under the polymerization conditions and are typically used in the production of superabsorbents. These include thermal initiators, redox initiators and photoinitiators, which are activated by means of high-energy radiation. The polymerization initiators may be present dissolved or dispersed in a solution of inventive monomers. Preference is given to the use of water-soluble initiators.

Useful thermal initiators include all compounds which decompose to free radicals when heated and are known to those skilled in the art. Particular preference is given to thermal polymerization initiators having a half-life of less than 10 seconds, further preferably of less than 5 seconds at less than 180° C., further preferably at less than 140° C. Peroxides, hydroperoxides, hydrogen peroxide, persulphates and azo compounds are particularly preferred thermal polymerization initiators. In some cases, it is advantageous to use mixtures of different thermal polymerization initiators. Among these mixtures, preference is given to those of hydrogen peroxide and sodium peroxodisulphate or potassium peroxodisulphate, which can be used in any conceivable ratio. Suitable organic peroxides are preferably acetylacetone peroxide, methyl ethyl ketone peroxide, benzoyl peroxide, lauroyl peroxide, acetyl peroxide, capryl peroxide, isopropyl peroxydicarbonate, 2-ethylhexyl peroxydicarbonate, t-butyl hydroperoxide, cumene hydroperoxide, t-amyl perpivalate, t-butyl perpivalate, t-butyl perneohexanoate, t-butyl isobutyrate, t-butyl per-2-ethylhexenoate, t-butyl perisononanoate, t-butyl permaleate, t-butyl perbenzoate, t-butyl 3,5,5-trimethylhexanoate and amyl perneodecanoate. Further preferred thermal polymerization initiators are: azo compounds such as azobisisobutyronitrile, azobisdimethylvaleronitrile, 2,2′-azobis(2-amidinopropane)dihydrochloride, azobisamidinopropane dihydrochloride, 2,2′-azobis(N,N-dimethylene)isobutyramidine dihydrochloride, 2-(carbamoylazo)isobutyronitrile and 4,4′-azobis(4-cyanovaleric acid). The compounds mentioned are used in customary amounts, preferably within a range from 0.01 to 5 mol %, preferably from 0.1 to 2 mol %, based in each case on the amount of the monomers to be polymerized.

The redox initiators comprise, as the oxidic component, at least one of the above-specified per compounds, and, as the reducing component, preferably ascorbic acid, glucose, sorbose, mannose, ammonium hydrogensulphite, sulphate, thiosulphate, hyposulphite or sulphide, alkali metal hydrogensulphite, sulphate, thiosulphate, hyposulphite or sulphide, metal salts such as iron(II) ions or silver ions, or sodium hydroxymethylsulphoxylate. The reducing component used in the redox initiator is preferably ascorbic acid or sodium pyrosulphite. Based on the amount of monomers used in the polymerization, 1×10⁻⁵ to 1 mol % of the reducing component of the redox initiator and 1×10⁻⁵ to 5 mol % of the oxidizing component of the redox initiator are used. Instead of the oxidizing component of the redox initiator, or in addition thereto, it is possible to use one or more, preferably water-soluble, azo compounds.

If the polymerization is triggered by the action of high-energy radiation, it is customary to use what are called photoinitiators as the initiator. These may be, for example, what are called α-splitters, H-abstracting systems, or else azides. Examples of such initiators are benzophenone derivatives such as Michler's ketone, phenanthrene derivatives, fluorene derivatives, anthraquinone derivatives, thioxanthone derivatives, coumarin derivatives, benzoin ethers and derivatives thereof, azo compounds such as the abovementioned free-radical formers, substituted hexaarylbisimidazoles or acylphosphine oxides. Examples of azides are: 2-(N,N-dimethylamino)ethyl 4-azidocinnamate, 2-(N,N-dimethylamino)ethyl 4-azidonaphthyl ketone, 2-(N,N-dimethylamino)ethyl 4-azidobenzoate, 5-azido-1-naphthyl 2′-(N,N-dimethylamino)ethyl sulphone, N-(4-sulphonylazidophenyl)maleimide, N-acetyl-4-sulphonylazidoaniline, 4-sulphonylazidoaniline, 4-azidoaniline, 4-azidophenacyl bromide, p-azidobenzoic acid, 2,6-bis(p-azidobenzylidene)cyclohexanone and 2,6-bis(p-azido-benzylidene)-4-methylcyclohexanone. If they are used, the photoinitiators are employed typically in amounts of 0.01 to 5% by weight, based on the monomers to be polymerized.

Preference is given in accordance with the invention to using an initiator system consisting of hydrogen peroxide, sodium peroxodisulphate and ascorbic acid. In general, the polymerization is initiated with the initiators within a temperature range from 0° C. to 90° C.

The polymerization reaction can be triggered by one initiator or by a plurality of interacting initiators. In addition, the polymerization can be performed in such a way that one or more redox initiators are first added. Later in the polymerization, thermal initiators or photoinitiators are then applied additionally, and the polymerization reaction in the case of photoinitiators is then initiated by the action of high-energy radiation. The reverse sequence, i.e. the initial initiation of the reaction by means of high-energy radiation and photoinitiators or thermal initiators and initiation of the polymerization by means of one or more redox initiators later in the polymerization, is also conceivable.

In order to convert the hydrogel polymers (PC) thus obtained to a particulate form, they can first, after they have been removed from the reaction mixture, be dried at a temperature within a range from 20 to 300° C., preferably within a range from 50 to 250° C. and more preferably within a range from 100 to 200° C., down to a water content of less than 40% by weight, preferably of less than 20% by weight and further preferably of less than 10% by weight, based in each case on the total weight of the hydrogel polymer (PC). The drying is effected preferably in ovens or driers known to those skilled in the art, for example in belt driers, staged driers, rotary tube ovens, fluidized bed driers, pan driers, paddle driers or infrared driers.

According to the present invention, the comminution is preferably effected by dry grinding, preferably by dry grinding in a hammer mill, a pinned disc mill, a ball mill or a roll mill. In a further version of the present invention, the hydrogel polymer can also be comminuted by the combinations of two or more of the above-described mills.

In a preferred embodiment of the processes according to the invention, the water-absorbing polymers obtained are particles having an inner region and a surface region bordering the inner region. The surface region has a different chemical composition from the inner region, or differs from the inner region in a physical property. Physical properties in which the inner region differs from the surface region are, for example, the charge density or the degree of crosslinking.

These water-absorbing polymers having an inner region and a surface region bordering the inner region are preferably obtainable by postcrosslinking reactive groups close to the surface of the particles of the particulate hydrogel polymer (PC). This postcrosslinking can be effected thermally, photochemically or chemically.

Preferred postcrosslinkers are the compounds of crosslinker classes II and IV mentioned in connection with the crosslinkers (α3). Among these compounds, particularly preferred postcrosslinkers are diethylene glycol, triethylene glycol, polyethylene glycol, glycerol, polyglycerol, propylene glycol, diethanolamine, triethanolamine, polyoxypropylene, oxyethylene-oxypropylene block copolymers, sorbitan fatty acid esters, polyoxyethylenesorbitan fatty acid esters, trimethylolpropane, pentaerythritol, polyvinyl alcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one.

Particular preference is given to using ethylene carbonate as the postcrosslinker.

Preferred embodiments of the water-absorbing polymers are those which are postcrosslinked by crosslinkers of the following crosslinker classes or by crosslinkers of the following combinations of crosslinker classes: II, IV and II IV.

The postcrosslinker is preferably used in an amount within a range from 0.01 to 30% by weight, more preferably in an amount within a range from 0.1 to 20% by weight and further preferably in an amount within a range from 0.3 to 5% by weight, based in each case on the weight of the superabsorbent polymers in the postcrosslinking.

It is likewise preferred that the postcrosslinking is effected by contacting a solvent comprising preferably water, water-miscible organic solvents, for instance methanol or ethanol or mixtures of at least two thereof, and the postcrosslinker with the outer region of the hydrogel polymer particles at a temperature within a range from 30 to 300° C., more preferably within a range from 100 to 200° C. The contacting is preferably effected by spraying the mixture consisting of postcrosslinker and solvent onto the hydrogel polymer particles and then mixing the hydrogel polymer particles contacted with the mixture. The postcrosslinker is present in the mixture preferably in an amount within a range from 0.01 to 20% by weight, more preferably in an amount within a range from 0.1 to 10% by weight, based on the total weight of the mixture. It is additionally preferred that contact with the hydrogel polymer particles is effected in an amount within a range from 0.01 to 50% by weight, more preferably in an amount within a range from 0.1 to 30% by weight, based in each case on the weight of the hydrogel polymer particles.

Useful condensation reactions preferably include the formation of ester, amide, imide or urethane bonds, preference being given to the formation of ester bonds.

The inventive hydrogel polymers and/or water-absorbing polymers can additionally be admixed with further additives and effect substances.

Preferred additives are additionally release agents, for instance inorganic or organic pulverulent release agents. These release agents are preferably used in amounts within a range from 0 to 2% by weight, more preferably within a range from 0.1 to 1.5% by weight, based on the weight of the hydrogel polymer and/or of the water-absorbing polymer. Preferred release agents are wood flour, pulp fibers, powdered bark, cellulose powder, mineral fillers such as perlite, synthetic fillers such as nylon powder, rayon powder, diatomaceous earth, bentonite, kaolin, zeolites, talc, loam, ash, carbon dust, magnesium silicates, fertilizers or mixtures of the substances. Finely divided fumed silica, as sold under the Aerosil trade name by Evonik Degussa, is preferred.

In a further preferred embodiment of the process according to the invention, the hydrogel polymer particles and/or the water-absorbing polymer particles are contacted with an effect substance, for example a polysugar, a polyphenolic compound, for example hydrolysable tannins or a compound containing silicon-oxygen, or a mixture of at least two effect substances based thereon. The effect substance can be added either in solid form (powder) or in dissolved form with a solvent, the effect substance being added not earlier than after process step iii). In the context of the present invention, an effect substance is understood to mean a substance which serves for odor inhibition.

According to the invention, this is understood to mean polysugars, by which the person skilled in the art understands those from the group of the familiar starches and derivatives thereof, celluloses and derivatives thereof, cyclodextrins. Cyclodextrins are preferably understood to mean α-cyclodextrin, β-cyclodextrin, γ-cyclodextrin or mixtures of these cyclodextrins.

Preferred compounds containing silicon-oxygen are zeolites. The zeolites used may be all synthetic or natural zeolites known to those skilled in the art. Preferred natural zeolites are zeolites from the natrolite group, the harmotone group, the mordenite group, the chabasite group, the faujasite group (sodalite group) or the analcite group. Examples of natural zeolites are analcime, leucite, pollucite, wairakite, bellbergite, bikitaite, boggsite, brewsterite, chabazite, willhendersonite, cowlesite, dachiardite, edingtonite, epistilbite, erionite, faujasite, ferrierite, amicite, garronite, gismondine, gobbinsite, gmelinite, gonnardite, goosecreekite, harmotome, phillipsite, wellsite, clinoptilolite, heulandite, laumontite, levyne, mazzite, merlinoite, montesommaite, mordenite, mesolite, natrolite, scolecite, offretite, paranatrolite, paulingite, perlialite, barrerite, stilbite, stellerite, thomsonite, tschernichite or yugawaralite. Preferred synthetic zeolites are zeolite A, zeolite X, zeolite Y, zeolite P, or the product ABSCENTS®.

The cations present in the zeolites used in the process according to the invention are preferably alkali metal cations such as Li⁺, Na⁺, K⁺, Rb⁺, Cs⁺ or Fr⁺ and/or alkaline earth metal cations such as Mg²⁺, Ca²⁺, Sr²⁺ or Ba²⁺.

The zeolites used may be zeolites of what is called the “intermediate” type, in which the SiO₂/AlO₂ ratio is less than 10; the SiO₂/AlO₂ ratio of these zeolites is more preferably within a range from 2 to 10. In addition to these “intermediate” zeolites, it is also possible to use zeolites of the “high” type, which include, for example, the known “molecular sieve” zeolites of the ZSM type, and beta-zeolite. These “high” zeolites are preferably characterized by an SiO₂/AlO₂ ratio of at least 35, more preferably by an SiO₂/AlO₂ ratio within a range from 200 to 500.

The zeolites are preferably used in the form of particles with a mean particle size within a range from 1 to 500 μm, more preferably within a range from 2 to 200 μm and further preferably within a range from 5 to 100 μm.

The effect substances are used in the processes according to the invention preferably in an amount within a range from 0.1 to 50% by weight, more preferably within a range from 1 to 40% by weight and further preferably in an amount within a range from 5 to 30% by weight, based in each case on the weight of the hydrogel polymer particles and/or water-absorbing polymer particles.

Preferred microbe-inhibiting substances are in principle all substances active against Gram-positive bacteria, for example 4-hydroxybenzoic acid and salts and esters thereof, N-(4-chlorophenyl)-N′-(3,4-dichlorophenyl)urea, 2,4,4′-trichloro-2′-hydroxydiphenyl ether (triclosan), 4-chloro-3,5-dimethylphenol, 2,2′-methylenebis(6-bromo-4-chlorophenol), 3-methyl-4-(1-methylethyl)phenol, 2-benzyl-4-chlorophenol, 3-(4-chlorophenoxy)-1,2-propanediol, 3-iodo-2-propynyl butylcarbamate, chlorhexidine, 3,4,4′-trichlorocarbonilide (TTC), antibacterial fragrances, thymol, thyme oil, eugenol, clove oil, menthol, mint oil, farmesol, phenoxyethanol, glyceryl monocaprate, glyceryl monocaprylate, glyceryl monolaurate (GML), diglyceryl monocaprate (DMC), N-alkylsalicylamides, for example N-n-octylsalicylamide or N-n-decylsalicylamide.

Suitable enzyme inhibitors are, for example, esterase inhibitors. These are preferably trialkyl citrates such as trimethyl citrate, tripropyl citrate, triisopropyl citrate, tributyl citrate and especially triethyl citrate (Hydagen™ CAT, Cognis GmbH, Dusseldorf, Germany). The substances inhibit enzyme activity and as a result reduce odor formation. Further substances useful as esterase inhibitors are sterol sulphates or phosphates, for example lanosterol sulphate or phosphate, cholesterol sulphate or phosphate, campesterol sulphate or phosphate, stigmasterol sulphate or phosphate and sitosterol sulphate or phosphate, dicarboxylic acids and esters thereof, for example glutaric acid, monoethyl glutarate, diethyl glutarate, adipic acid, monoethyl adipate, diethyl adipate, malonic acid and diethyl malonate, hydroxycarboxylic acids and esters thereof, for example citric acid, malic acid, tartaric acid or diethyl tartrate, and zinc glycinate.

Suitable odor absorbers are substances which can absorb and substantially retain odor-forming compounds. They lower the partial pressure of the individual components and thus also reduce the rate of spread thereof. It is important that perfumes must remain unimpaired. Odour absorbers have no effect against bacteria. They contain, for example, as the main constituent, a complex zinc salt of ricinoleic acid or specific, substantially odor-neutral fragrances known to the person skilled in the art as “fixatives”, for example extracts of labdanum or styrax or particular abietic acid derivatives. The function of odor maskers is fulfilled by odorants or perfume oils which, in addition to their function as odor maskers, impart their particular fragrance note to the deodorants. Examples of perfume oils include mixtures of natural and synthetic odorants. Natural odorants are extracts of flowers, stems and leaves, fruits, fruit skins, roots, woods, herbs and grasses, needles and twigs, and also resins and balsams. Additionally useful are animal raw materials, for example civet and castoreum. Typical synthetic odorant compounds are products of the ester, ether, aldehyde, ketone, alcohol and hydrocarbon type. Odorant compounds of the ester type are, for example, benzyl acetate, p-tert-butylcyclohexyl acetate, linalyl acetate, phenylethyl acetate, linalyl benzoate, benzyl formate, allyl cyclohexylpropionate, styrallyl propionate and benzyl salicylate. The ethers include, for example, benzyl ethyl ether; the aldehydes include, for example, the linear alkanals having 8 to 18 carbon atoms, citral, citronellal, citronellyloxyacetaldehyde, cyclamen aldehyde, hydroxycitronellal, lilial and bourgeonal; the ketones include, for example, the ionones and methyl cedryl ketone; the alcohols include anethole, citronellol, eugenol, isoeugenol, geraniol, linalool, phenylethyl alcohol and terpineol; the hydrocarbons include principally the terpenes and balsams. Preference is given, however, to using mixtures of different odorants which together produce a pleasing fragrance note. Suitable perfume oils are also essential oils of relatively low volatility which are usually used as aroma components, for example sage oil, camomile oil, clove oil, melissa oil, mint oil, cinnamon leaf oil, lime blossom oil, juniperberry oil, vetiver oil, olibanum oil, galbanum oil, labdanum oil and lavender oil. Preference is given to using bergamot oil, dihydromyrcenol, lilial, lyral, citronellol, phenylethyl alcohol, alpha-hexylcinnamaldehyde, geraniol, benzylacetone, cyclamen aldehyde, linalool, Boisambrene Forte, ambroxan, indole, Hedione, Sandelice, lemon oil, mandarin oil, orange oil, allyl amyl glycolate, cyclovertal, lavender oil, clary sage oil, beta-damascone, geranium oil bourbon, cyclohexyl salicylate, Vertofix Coeur, Iso-E-Super, Fixolide NP, Evernyl, iraldein gamma, phenylacetic acid, geranyl acetate, benzyl acetate, rose oxide, Romilat, Irotyl and Floramat, alone or in mixtures.

Antiperspirants reduce the formation of perspiration by influencing the activity of the eccrine sweat glands, and thus counteract underarm wetness and body odor. Suitable astringent active antiperspirant ingredients are in particular salts of aluminium, zirconium or zinc. Such suitable antihydrotically active ingredients are, for example, aluminium chloride, aluminium chlorohydrate, aluminium dichlorohydrate, aluminium sesquichlorohydrate and the complexes thereof, for example with propylene 1,2-glycol, aluminium hydroxyallantoinate, aluminium chloride tartrate, aluminium zirconium trichlorohydrate, aluminium zirconium tetrachlorohydrate, aluminium zirconium pentachlorohydrate and the complexes thereof, for example with amino acids such as glycine.

Suitable apparatus for mixing or spraying is any which allows homogeneous distribution of a solution, powder, suspension or dispersion on or with the hydrogel polymer particles (PC) or water-absorbing polymers. Examples are Lodige mixers (manufactured by Gebrüder Lödige Maschinenbau GmbH), Gericke multi-flux mixers (manufactured by Gericke GmbH), DRAIS mixers (manufactured by DRAIS GmbH Spezialmaschinenfabrik Mannheim), Hosokawa mixers (Hosokawa Mokron Co., Ltd.), Ruberg mixers (manufactured by Gebr. Ruberg GmbH & Co. KG Nieheim), Huttlin coaters (manufactured by BWI Hüttlin GmbH Steinen), fluidized bed driers or spray granulators from AMMAG (manufactured by AMMAG Gunskirchen, Austria) or Heinen (manufactured by A. Heinen AG Anlagenbau Varel), Patterson-Kelly mixers, NARA paddle mixers, screw mixers, pan mixers, fluidized bed driers or Schugi mixers. For contacting in a fluidized bed, it is possible to employ all fluidized bed processes which are known to those skilled in the art and appear to be suitable. For example, it is possible to use a fluidized bed coater.

A further contribution to the solution of the problems described at the outset is made by a composite including the inventive water-absorbing polymers or the hydrogel polymers, or the water-absorbing polymers or hydrogel polymers obtainable by the processes according to the invention, and a substrate. It is preferable that the inventive water-absorbing polymers or hydrogel polymers and the substrate are bonded in a fixed manner to one another. Preferred substrates are films of polymers, for example of polyethylene, polypropylene or polyamide, metals, nonwovens, fluff, tissues, fabrics, natural or synthetic fibers, or foams. It is additionally preferred in accordance with the invention that the composite comprises at least one region which includes water-absorbing polymers or hydrogel polymers in an amount in the range from about 15 to 100% by weight, preferably about 30 to 100% by weight, more preferably from about 50 to 99.99% by weight, further preferably from about 60 to 99.99% by weight and even further preferably from about 70 to 99% by weight, based in each case on the total weight of the region of the composite in question, this region preferably having a size of at least 0.01 cm³, preferably at least 0.1 cm³ and most preferably at least 0.5 cm³.

A further contribution to the solution of at least one of the problems stated at the outset is made by a process for producing a composite, wherein the inventive water-absorbing polymers or the superabsorbents obtainable by the process according to the invention and a substrate and optionally an additive are contacted with one another. The substrates used are preferably those substrates which have already been mentioned above in connection with the inventive composite.

A contribution to the solution of at least one of the problems stated at the outset is also made by a composite obtainable by the process described above, this composite preferably having the same properties as the above-described inventive composite.

A further contribution to the solution of at least one of the problems stated at the outset is made by chemical products including the inventive water-absorbing polymers or hydrogel polymers or an inventive composite. Preferred chemical products are especially foams, moldings, fibers, foils, films, cables, sealing materials, liquid-absorbing hygiene articles, especially diapers and sanitary towels, carriers for plant growth or fungal growth regulators or plant protection active ingredients, additives for building materials, packaging materials or soil additives.

The use of the inventive water-absorbing polymers or of the inventive composite in chemical products, preferably in the aforementioned chemical products, especially in hygiene articles such as diapers or sanitary towels, and the use of the water-absorbing polymer particles as carriers for plant growth or fungal growth regulators or plant protection active ingredients also make a contribution to the achievement of at least one of the problems stated at the outset. In the case of use as a carrier for plant growth or fungal growth regulators or plant protection active ingredients, it is preferred that the plant growth or fungal growth regulators or plant protection active ingredients can be released over a period controlled by the carrier.

### Test Methods

Unless stated otherwise hereinafter, the measurements conducted herein are according to ERT methods. “ERT” stands for EDANA Recommended Test and “EDANA” for European Disposables and Nonwovens Association. All test methods are in principle, unless stated otherwise, conducted at an ambient temperature of 23±2° C. and a relative air humidity of 50±10%.

### Particle Size Distribution (PSD)

The particle size distribution of the water-absorbing polymer particles is determined analogously to EDANA recommended test method No. WSP 220.3-10 “Particle Size Distribution”.

### Determination of the Free Swell Rate (FSR)

The absorption rate was determined via the measurement of what is called the Free Swell Rate—(FSR) by the test method described in EP-A-0 443 627 on page 12.

The Δ-FSR value corresponds to the quotient of

$$\frac{FSR ( SX ) - FSR ( VP )}{FSR ( VP )}$$

### EXAMPLES

The examples which follow serve for further illustration of the invention, but without restricting it thereto.

The inventive examples which follow show the synergistic effect on the FSR value by the simultaneous use of carbonate and an acidic compound and optionally a polymerizable surfactant. In the examples, a defined PSD was used in order to rule out any possible effects of the particle distribution within the examples (150 μm to 710 μm in Examples 1 to 4; or 150 μm to 850 μm in Examples 7 to 12). In this context, a defined particle size distribution (PSD) was used (150 μm to 710 μm). The standard mixture used is a composition of 4 particle fractions prior to surface postcrosslinking, which have the following distribution in Examples 1 to 4: 15% by weight of a particle size from 150 μm to 300 μm; 50% by weight 300 μm to 500 μm; 30% by weight 500 μm to 600 μm and 5% by weight 600 μm to 710 μm. The PSD is established for the hydrogel polymers. For Examples 5 and 6, the standard mixture used was a composition of 4 particle fractions which had the following distribution: 15% by weight of a particle size from 150 μm to 300 μm; 25% by weight 300 μm to 500 μm; 35% by weight 500 μm to 710 μm and 25% by weight 710 μm to 850 μm.

EP1 701786 B1, in paragraphs [0115 to 0117], defines the mass average of the particle diameter as D50. According to the invention, preference is given to a range between 300 and 600 μm. Particular preference is given to a range from 350 to 550 μm, and very particular preference to a range between 400 and 500 μm. Preference is given to a blowing agent in which more than 35% by weight of the particles have a particle size of 100-300 μm. The term “SX” as used in the description is understood to mean the thermal surface postcrosslinking of the precursor (PC). The precursor corresponds to the hydrogel polymer obtained after the first drying, with the aforementioned particle distribution. In principle, the percentages for the surfactant are based on the acrylic acid (unless stated otherwise, 320 g) and those for the carbonate on the mixture (1000 g).

### EXAMPLES

In the examples, a defined PSD was used in order to rule out any possible effects of the particle distribution within the examples (150 μm to 710 μm in Examples 1 to 4; or 150 μm to 850 μm in Examples 5 and 6).

The additives used were Pluriol A23 R (BASF) and Polyether PE 7316/02 (Evonik Industries AG). In principle, the percentages of the surfactant relate to the acrylic acid (unless stated otherwise, 640 g), and those of the carbonate to the mixture (normally 2000 g).

Use without polymerizable surfactant and sodium carbonate:

### Example 1 (Reference)

1.517 g of polyethylene glycol-300 diacrylate (0.20% based on acrylic acid/ester content corresponding to 84%) and 3.29 g of polyethylene glycol-750 monoallyl ether acrylate (0.40% based on acrylic acid/ester content corresponding to 78%) as crosslinker were dissolved in 1972.423 g of an aqueous solution of sodium acrylate with a neutralization level of 70 mol % (based on acrylic acid) and a total monomer concentration of 39.38%. The monomer solution was purged with nitrogen in a plastic polymerization vessel for 30 minutes in order to remove the dissolved oxygen. At a temperature of 4° C., the polymerization was initiated by the successive addition of 0.6 g of sodium peroxodisulphate in 10 g of dist. water, 0.14 g of 35% hydrogen peroxide solution in 10 g of dist. water and 0.03 g of ascorbic acid in 2 g of dist. water. Once the end temperature (approx. 100° C.) had been attained, the gel was comminuted with a meat grinder and dried at 150° C. in an air circulation drying cabinet for 2 h.

The after treatment of the precursors obtained (Examples 1 to 12) was effected in Example A by post-heating at 170° C. over a period of 90 min in a drying cabinet;

in Example B by coating with 3 parts water based on 100 g of superabsorbent and subsequent post-heating at 170° C. over a period of 90 min in a drying cabinet;
in Example C by coating with a solution consisting of ethylene carbonate/water/aluminium lactate/aluminium sulphate in a ratio of 1/3/0.4/0.3% based on 100 g of superabsorbent and subsequent post-heating at 170° C. over a period of 90 min;
in Example D by coating with a solution consisting of ethylene carbonate/water/aluminium lactate/aluminium sulphate in a ratio of 1/3/0.3/0.2% based on 100 g of superabsorbent and subsequent post-heating at 170° C. over a period of 90 min;
in Example E by coating with a solution consisting of ethylene carbonate/water/aluminium lactate in a ratio of 1/3/0.4% based on 100 g of superabsorbent and subsequent post-heating at 170° C. over a period of 90 min;
in Example F by coating with a solution consisting of ethylene carbonate/water/aluminium sulphate in a ratio of 1/3/0.3% based on 100 g of superabsorbent and subsequent post-heating at 170° C. over a period of 90 min;
in Example G by coating with a solution consisting of ethylene carbonate/water in a ratio of ⅓% based on 100 g of superabsorbent with citric acid added up to a pH of about 3.7 and subsequent post-heating at 170° C. over a period of 90 min;
in Example H by coating with a solution consisting of ethylene carbonate/water in a ratio of ⅓% based on 100 g of superabsorbent with phosphoric acid added up to a pH of about 3.7 and subsequent post-heating at 170° C. over a period of 90 min;
in Example I by coating with a solution consisting of ethylene carbonate/water in a ratio of ⅓% based on 100 g of superabsorbent with hydrochloric acid added up to a pH of about 3.7 and subsequent post-heating at 170° C. over a period of 90 min;
in Example J by coating with a solution consisting of ethylene carbonate/water/sodium dihydrogencitrate in a ratio of 1/3/1.5 or 0.4% based on 100 g of superabsorbent and subsequent post-heating at 170° C. over a period of 90 min;
in Example K by coating with a solution consisting of ethylene carbonate/water/potassium hydrogensulphate in a ratio of 1/3/1 or 0.25% based on 100 g of superabsorbent and subsequent post-heating at 170° C. over a period of 90 min and
in Example L by coating with a solution consisting of ethylene carbonate/water/aluminium(III) chloride in a ratio of 1/3/0.15% based on 100 g of superabsorbent and subsequent post-heating at 170° C. over a period of 90 min. The results for the Examples 1 are summarized in Table 1:

TABLE 1
(reference)

| | | | | Al | | pH | | FSR | FSR | |
|---|---|---|---|---|---|---|---|---|---|---|
| Example | Additions | EC | H2O | lactate | Al sulphate | of the | Drying | (VP) | (SX) | ΔFSR |
| No. | [%] | [%] | [%] | [%] | [%] | mixture | conditions | [g/g/s] | [g/g/s] | [g/g/s] |
| 1 | | | | | | | | 0.27 | | |
| 1A | | — | — | — | — | — | 170° C./90 min. | | 0.24 | −0.03 |
| 1B | | | 3 | — | — | | 170° C./90 min. | | 0.14 | −0.13 |
| 1C | | 1 | 3 | 0.4 | 0.3 | 3.8 | 170° C./90 min. | | 0.27 | 0.0 |
| 1G | citric acid | 1 | 3 | | | 3.7 | 170° C./90 min. | | 0.27 | 0.0 |
| 1H | phosphoric acid | 1 | 3 | | | 3.7 | 170° C./90 min. | | 0.26 | −0.01 |
| 1I | hydrochloric | 1 | 3 | | | 3.7 | 170° C./90 min. | | 0.26 | −0.01 |
| | acid | | | | | | | | | |

Use without polymerizable surfactant and 0.5% light sodium carbonate

### Example 2

1.137 g of polyethylene glycol-300 diacrylate (0.15% based on acrylic acid/ester content corresponding to 84%) and 2.468 g of polyethylene glycol-750 monoallyl ether acrylate (0.30% based on acrylic acid/ester content corresponding to 78%) as crosslinker were dissolved in 1963.625 g of an aqueous solution of sodium acrylate with a neutralization level of 70 mol % (based on acrylic acid) and a total monomer concentration of 39.55%. The monomer solution was purged with nitrogen in a plastic polymerization vessel for 30 minutes in order to remove the dissolved oxygen. At a temperature of 4° C., 10 g of finely calcined sodium carbonate (from Solvay) was added and the polymerization was initiated by the successive addition of 0.6 g of sodium peroxodisulphate in 10 g of dist. water, 0.14 g of 35% hydrogen peroxide solution in 10 g of dist. water and 0.03 g of ascorbic acid in 2 g of dist. water. Once the end temperature (approx. 100° C.) was attained, the gel was comminuted with a meat grinder and dried at 150° C. in an air circulation drying cabinet for 2 h.

The results for the Examples 2 are summarized in Table 2:

TABLE 2
(addition of 0.5% sodium carbonate)

| | | | | Al | | pH | | FSR | FSR | |
|---|---|---|---|---|---|---|---|---|---|---|
| Example | Additions | EC | H2O | lactate | Al sulphate | of the | Drying | (VP) | (SX) | ΔFSR |
| No. | [%] | [%] | [%] | [%] | [%] | mixture | conditions | [g/g/s] | [g/g/s] | [g/g/s] |
| 2 | | | | | | | | 0.43 | | |
| 2A | | — | — | — | — | | 170° C./ | | 0.46 | 0.06 |
| | | | | | | | 90 min. | | | |
| 2B | | | 3 | — | — | 6.9 | 170° C./ | | 0.26 | −0.3 |
| | | | | | | | 90 min. | | | |
| 2C | | 1 | 3 | 0.4 | 0.3 | 3.8 | 170° C./ | | 0.51 | 0.18 |
| | | | | | | | 90 min. | | | |
| 2G | citric acid | 1 | 3 | | | 3.7 | 170° C./ | | 0.47 | 0.09 |
| | | | | | | | 90 min. | | | |
| 2H | phosphoric acid | 1 | 3 | | | 3.7 | 170° C./ | | 0.52 | 0.2 |
| | | | | | | | 90 min. | | | |
| 2I | hydrochloric | 1 | 3 | | | 3.7 | 170° C./ | | 0.52 | 0.2 |
| | acid | | | | | | 90 min. | | | |

Use with Pluriol A23R polymerizable surfactant and 0.5% light sodium carbonate

### Example 3

1.137 g of polyethylene glycol-300 diacrylate (0.15% based on acrylic acid/ester content, corresponding to 84%) and 2.468 g of polyethylene glycol-750 monoallyl ether acrylate (0.30% based on acrylic acid/ester content, corresponding to 78%) as crosslinker were dissolved in 1944.425 g of an aqueous solution of sodium acrylate with a neutralization level of 70 mol % (based on acrylic acid) and a total monomer concentration of 39.94%. Subsequently, 19.2 g of a 10% aqueous solution of the Pluriol A23R comonomer were added to the solution, and the monomer solution was purged with nitrogen in a plastic polymerization vessel for 30 minutes in order to remove the dissolved oxygen. At a temperature of 4° C., 10 g of finely calcined sodium carbonate (from Solvay) were added and the polymerization was initiated by the successive addition of 0.6 g of sodium peroxodisulphate in 10 g of distilled water, 0.14 g of 35% hydrogen peroxide solution in 10 g of distilled water and 0.03 g of ascorbic acid in 2 g of distilled water. Once the end temperature (approx. 100° C.) had been attained, the gel was comminuted with a meat grinder and dried at 150° C. in an air circulation drying cabinet for 2 h.

The results for the Examples 3 are summarized in Table 3:

TABLE 3
(addition of 0.3% Pluriol A23R and 0.5% sodium carbonate)

| | | | | Al | | | | FSR | FSR | |
|---|---|---|---|---|---|---|---|---|---|---|
| Example | Additions | EC | H2O | lactate | Al sulphate | pH of the | Drying | (VP) | (SX) | ΔFSR |
| No. | [%] | [%] | [%] | [%] | [%] | mixture | conditions | [g/g/s] | [g/g/s] | [g/g/s] |
| 3 | | | | | | | | 0.47 | | |
| 3A | | — | — | — | — | | 170° C./ | | 0.48 | 0.01 |
| | | | | | | | 90 min. | | | |
| 3B | | | 3 | — | — | 6.9 | 170° C./ | | 0.36 | −0.2 |
| | | | | | | | 90 min. | | | |
| 3C | | 1 | 3 | 0.4 | 0.3 | 3.8 | 170° C./ | | 0.66 | 0.4 |
| | | | | | | | 90 min. | | | |
| 3G | citric acid | 1 | 3 | | | 3.7 | 170° C./ | | 0.58 | 0.23 |
| | | | | | | | 90 min. | | | |
| 3H | phosphoric acid | 1 | 3 | | | 3.7 | 170° C./ | | 0.63 | 0.34 |
| | | | | | | | 90 min. | | | |
| 3I | hydrochloric | 1 | 3 | | | 3.7 | 170° C./ | | 0.66 | 0.4 |
| | acid | | | | | | 90 min. | | | |

*anhydrous sodium dihydrogencitrate (Fluka)
**potassium hydrogensulphate (Merck)

Use with PE 7316/02 polymerizable surfactant and 0.15% light sodium carbonate

### Example 4

1.365 g of polyethylene glycol-300 diacrylate (0.18% based on acrylic acid/ester content, corresponding to 84%) and 2.961 g of polyethylene glycol-750 monoallyl ether acrylate (0.36% based on acrylic acid/ester content, corresponding to 78%) as crosslinker were dissolved in 1960.304 g of an aqueous solution of sodium acrylate with a neutralization level of 70 mol % (based on acrylic acid) and a total monomer concentration of 39.62%. Subsequently, 9.6 g of a 10% aqueous solution of PE 7316/02 were added. The monomer solution was purged with nitrogen in a plastic polymerization vessel for 30 minutes in order to remove the dissolved oxygen. At a temperature of 4° C., 3 g of finely calcined sodium carbonate (from Solvay) were added and the polymerization was initiated by the successive addition of 0.6 g of sodium peroxodisulphate in 10 g of distilled water, 0.14 g of 35% hydrogen peroxide solution in 10 g of distilled water and 0.03 g of ascorbic acid in 2 g of distilled water. Once the end temperature (approx. 100° C.) had been attained, the gel was comminuted with a meat grinder and dried at 150° C. in an air circulation drying cabinet for 2 h.

The results for the Examples 4 are summarized in Table 4:

TABLE 4
(addition of 0.15% PE 7316/02 and 0.15% sodium carbonate)

| | | | | Al | | | | FSR | FSR | |
|---|---|---|---|---|---|---|---|---|---|---|
| Example | Additions | EC | H2O | lactate | Al sulphate | pH of the | Drying | (VP) | (SX) | ΔFSR |
| No. | [%] | [%] | [%] | [%] | [%] | mixture | conditions | [g/g/s] | [g/g/s] | [g/g/s] |
| 4 | | | | | | | | 0.39 | | |
| 4A | | — | — | — | — | | 170° C./ | | 0.37 | −0.02 |
| | | | | | | | 90 min. | | | |
| 4B | | | 3 | — | — | 6.9 | 170° C./ | | 0.32 | 0.15 |
| | | | | | | | 90 min. | | | |
| 4C | | 1 | 3 | 0.4 | 0.3 | 3.8 | 170° C./ | | 0.49 | 0.23 |
| | | | | | | | 90 min. | | | |
| 4D | | 1 | 3 | 0.3 | 0.2 | 3.8 | 170° C./ | | 0.43 | 0.09 |
| | | | | | | | 90 min. | | | |
| 4E | | 1 | 3 | 0.4 | | 4.9 | 170° C./ | | 0.48 | 0.2 |
| | | | | | | | 90 min. | | | |
| 4F | | 1 | 3 | | 0.3 | 2.9 | 170° C./ | | 0.45 | 0.13 |
| | | | | | | | 90 min. | | | |
| 4K | **1.0% potassium | 1 | 3 | | | 0.8 | 170° C./ | | 0.43 | 0.09 |
| | hydrogen- | | | | | | 90 min. | | | |
| | sulphate | | | | | | | | | |

**Potassium hydrogensulphate (Merck)

### Example 5

1.365 g of polyethylene glycol-300 diacrylate (0.18% based on acrylic acid/ester content, corresponding to 84%) and 2.961 g of polyethylene glycol-750 monoallyl ether acrylate (0.36% based on acrylic acid/ester content, corresponding to 78%) as crosslinker were to dissolved in 1969.904 g of an aqueous solution of sodium acrylate with a neutralization level of 70 mol % (based on acrylic acid) and a total monomer concentration of 39.43%. The monomer solution was purged with nitrogen in a plastic polymerization vessel for 30 minutes in order to remove the dissolved oxygen. At a temperature of 4° C., 3 g of finely calcined sodium carbonate (from Solvay) were added and the polymerization was initiated by the successive addition of 0.6 g of sodium peroxodisulphate in 10 g of distilled water, 0.14 g of 35% hydrogen peroxide solution in 10 g of distilled water and 0.03 g of ascorbic acid in 2 g of distilled water. Once the end temperature (approx. 100° C.) had been attained, the gel was comminuted with a meat grinder and dried at 150° C. in an air circulation drying cabinet for 2 h.

The results for the Examples 5 are summarized in Table 5:

TABLE 5
(addition of 0.15% sodium carbonate)

| | | | | Al | | | | FSR | FSR | |
|---|---|---|---|---|---|---|---|---|---|---|
| Example | Additions | EC | H2O | lactate | Al sulphate | pH of the | Drying | (VP) | (SX) | ΔFSR |
| No. | [%] | [%] | [%] | [%] | [%] | mixture | conditions | [g/g/s] | [g/g/s] | [g/g/s] |
| 5 | | | | | | | | 0.33 | | |
| 5A | | — | — | — | — | | 170° C./ | | 0.19 | −0.29 |
| | | | | | | | 90 min. | | | |
| 5B | | | 3 | — | — | 6.9 | 170° C./ | | 0.27 | −0.16 |
| | | | | | | | 90 min. | | | |
| 5C | | 1 | 3 | 0.4 | 0.3 | 3.8 | 170° C./ | | 0.37 | 0.09 |
| | | | | | | | 90 min. | | | |
| 5F | | 1 | 3 | | 0.3 | 2.9 | 170° C./ | | 0.37 | 0.09 |
| | | | | | | | 90 min. | | | |
| 5L | *0.15% | 1 | 3 | | | 2.7 | 170° C./ | | 0.40 | 0.21 |
| | aluminium(III) | | | | | | 90 min. | | | |
| | chloride | | | | | | | | | |

*AlCl₃×6H₂O (Merck)

Use of polymerizable surfactant PE 7316/02 and 0.15% light sodium carbonate

### Example 6

1.365 g of polyethylene glycol-300 diacrylate (0.18% based on acrylic acid/ester content corresponding to 84%) and 2.961 g of polyethylene glycol-750 monoallyl ether acrylate (0.36% based on acrylic acid/ester content corresponding to 78%) as crosslinker were to dissolved in 1960.304 g of an aqueous solution of sodium acrylate with a neutralization level of 70 mol % (based on acrylic acid) and a total monomer concentration of 39.62%. Subsequently, 9.6 g of a 10% aqueous solution of PE 7316/02 were added. The monomer solution was purged with nitrogen in a plastic polymerization vessel for 30 minutes in order to remove the dissolved oxygen. At a temperature of 4° C., 3 g of finely calcined sodium carbonate (from Solvay) was added and the polymerization was initiated by the successive addition of 0.6 g of sodium peroxodisulphate in 10 g of dist. water, 0.14 g of 35% hydrogen peroxide solution in 10 g of dist. water and 0.03 g of ascorbic acid in 2 g of dist. water. Once the end temperature (approx. 100° C.) was attained, the gel was comminuted with a meat grinder and dried at 150° C. in an air circulation drying cabinet for 2 h.

The results for Examples 6 are summarized in Table 6:

TABLE 6
(addition of 0.15% PE 7316/02 and 0.15% sodium carbonate)

| | | | | Al | | | | FSR | FSR | |
|---|---|---|---|---|---|---|---|---|---|---|
| Example | Additions | EC | H2O | lactate | Al sulphate | pH of the | Drying | (VP) | (SX) | ΔFSR |
| No. | [%] | [%] | [%] | [%] | [%] | mixture | conditions | [g/g/s] | [g/g/s] | [g/g/s] |
| 6 | | | | | | | | 0.37 | | |
| 6A | | — | — | — | — | | 170° C./ | | 0.20 | −0.38 |
| | | | | | | | 90 min. | | | |
| 6B | | | 3 | — | — | 6.9 | 170° C./ | | 0.25 | −0.25 |
| | | | | | | | 90 min. | | | |
| 6C | | 1 | 3 | 0.4 | 0.3 | 3.8 | 170° C./ | | 0.39 | 0.05 |
| | | | | | | | 90 min. | | | |
| 6F | | 1 | 3 | | 0.3 | 2.9 | 170° C./ | | 0.43 | 0.16 |
| | | | | | | | 90 min. | | | |
| 6L | *0.15% | 1 | 3 | | | 2.7 | 170° C./ | | 0.42 | 0.14 |
| | aluminium (III) | | | | | | 90 min. | | | |
| | chloride | | | | | | | | | |

*AlCl₃×6H₂O (Merck)

1. A process for producing a water-absorbing polymer composition, comprising the process steps of
(i) mixing
(α1) 0.1 to 99.999% by weight of polymerizable, ethylenically unsaturated monomers containing acid groups, or salts thereof, or polymerizable, ethylenically unsaturated monomers including a protonated or quaternized nitrogen, or mixtures thereof,
(α2) 0 to 70% by weight of polymerizable, ethylenically unsaturated monomers copolymerizable with (α1),
(α3) 0.001 to 10% by weight of one or more crosslinkers,
(α4) 0 to 30% by weight of water-soluble polymers, and
(α5) 0 to 20% by weight of one or more assistants, where the sum of the weights of (α1) to (α5) is 100% by weight,
(ii) free-radical polymerization with crosslinking to form a water-insoluble, aqueous untreated hydrogel polymer,
(iii) drying the hydrogel polymer,
(iv) grinding and sieving the hydrogel polymer to size,
(v) surface postcrosslinking the ground and sieved hydrogel polymer and
(vi) drying and finishing the water-absorbing polymer
wherein
0.01 to 5% by weight of a blowing agent having a particle size of 10 μm to 900 μm are added, based on the hydrogel polymer, optionally 0.01 to 5% by weight of at least one surfactant from the group of the nonionic, ionic or amphoteric surfactants, and in steps (ii) to (v) additionally at least one acidic compound is added.

2. A process for producing a hydrogel polymer, comprising the process steps of
(i) mixing
(α1) 0.1 to 99.999% by weight of polymerizable, ethylenically unsaturated monomers containing acid groups, or salts thereof, or polymerizable, ethylenically unsaturated monomers including a protonated or quaternized nitrogen, or mixtures thereof,
(α2) 0 to 70% by weight of polymerizable, ethylenically unsaturated monomers copolymerizable with (α1),
(α3) 0.001 to 10% by weight of one or more crosslinkers,
(α4) 0 to 30% by weight of water-soluble polymers, and
(α5) 0 to 20% by weight of one or more assistants, where the sum of the weights of (α1) to (α5) is 100% by weight,
(ii) free-radical polymerization with crosslinking to form a water-insoluble, aqueous untreated hydrogel polymer,
(iii) drying the hydrogel polymer,
(iv) grinding and sieving the hydrogel polymer to size,
wherein
0.01 to 5% by weight of a blowing agent having a particle size of 10 μm to 900 μm are added, based on the hydrogel polymer, optionally 0.01 to 5% by weight of at least one surfactant from the group of the nonionic, ionic or amphoteric surfactants, and in steps (ii) to (iii) additionally at least one acidic compound are added.

3. The process according to claim 1, wherein the Δ-FSR is within the range from 0.01 to 0.50.

4. The process according to claim 1, wherein the blowing agents consist of a powder of inorganic particles.

5. The process according to claim 1, wherein the blowing agents consist of sodium carbonate particles.

6. The process according to claim 1, wherein the blowing agent has a particle size of 10 μm to 900 μm.

7. The process according to claim 1, wherein more than 35% by weight of the blowing agents have a particle size of 100-300 μm.

8. The process according to claim 1, wherein at least one acidic compound is added in step (ii) or prior to step (v).

9. The process according to claim 1, wherein at least one acidic compound from the group of acetic anhydride, maleic anhydride, fumaric anhydride, benzoic acid, formic acid, valeric acid, citric acid, glyoxylic acid, glycolic acid, glycerophosphoric acid, glutaric acid, chloroacetic acid, chloropropionic acid, cinnamic acid, succinic acid, acetic acid, tartaric acid, lactic acid, pyruvic acid, fumaric acid, propionic acid, 3-hydroxypropionic acid, malonic acid, butyric acid, isobutyric acid, imidinoacetic acid, malic acid, isethionic acid, methylmaleic acid, adipic acid, itaconic acid, crotonic acid, oxalic acid, salicylic acid, gluconic acid, gallic acid, sorbic acid, gluconic acid and p-hydroxybenzoic acid, tartaric acid, acid anhydrides, for instance P₂O₅, SO₂, N₂O, H₂SO₄ or HCl, mixtures of these or salts thereof is added.

10. The process according to claim 1, wherein the organic acidic compound used is preferably acetic anhydride, maleic anhydride, fumaric anhydride, benzoic acid, formic acid, valeric acid, citric acid, glyoxylic acid, glycolic acid, glycerophosphoric acid, glutaric acid, chloroacetic acid, chloropropionic acid, cinnamic acid, succinic acid, acetic acid, tartaric acid, lactic acid, pyruvic acid, fumaric acid.

11. The process according to claim 1, wherein the inorganic acids or acid anhydrides, for instance P₂O₅, SO₂, N₂O, H₂SO₄ or HCl, are added in steps (ii) and (iii).

12. The process according to claim 1, wherein the salts of sulphuric acid, phosphoric acid and citric acid are added, alone or in mixtures with other salts or organic acids.

13. The process according to claim 1, wherein the aqueous monomer solution is admixed with at least one surfactant from the group of the nonionic, ionic or amphoteric surfactants and 0.01 to 5% by weight of blowing agent with a particle size of 10 μm to 900 μm, based on the water-absorbing polymer.

14. The process according to claim 1, wherein the surfactant is preferably selected from the group of the nonionic surfactants.

15. The process according to claim 1, wherein the surfactant is formed from at least one ethylene glycol unit and from at least one further alkylene glycol unit which is different from the ethylene glycol unit and has 3 to 6 carbon atoms.

16. The process according to claim 1, wherein the surfactant is formed from at least one ethylene glycol unit and from at least one further unit from the group of propylene glycol or butylene glycol.

17. The process according to claim 1, wherein the unsaturated polymerizable surfactant contains at least one terminal functionality from the group of vinyl ether, (meth)allyl ether, 4-vinylbenzyl ether, (meth)acrylamide, methacrylic ester and acrylic ester groups.

18. The process according to claim 1, wherein the unsaturated polymerizable surfactants at least one terminal functionality from the group of vinyl ether, (meth)allyl ether, 4-vinylbenzyl ether, (meth)acrylamide, methacrylic ester and acrylic ester groups and an unpolymerizable end group functionality from the group of hydroxyl, hydroxyl group which may be etherified with an R radical or esterified with an O═CR radical.

19. The process according to claim 1, characterized in that the R radical from the group of linear or branched C₁- to C₁₀-alkyl radicals.

20. The process according to claim 1, wherein the unsaturated polyether surfactant, a compound of the following formula: 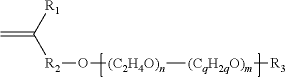
in which the alkylene glycol units (C₂H₄O) and (C_{q}H_{2q}O) are arranged randomly, in blocks or as a gradient, R₁ is —H or —CH₃, R₂ is a carbonyl group (C═O) and R₃ is —H, linear or branched C₁- to C₇-alkyls, C₆- to C₉-alkylaryls or C₁- to C₇-acyl radicals, q is a number from 3 to 4, n and m are each a number from 1 to 20.

21. The process according to claim 1, wherein the unsaturated polyether surfactant is a compound of the following formula: 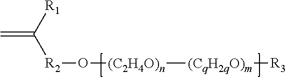
in which the alkylene glycol units (C₂H₄O) and (C_{q}H_{2q}O) are arranged randomly or as a gradient, R₁ is —H or —CH₃, R₂ is an alkylene group from the group of methylene or ethylene, and R₃ is —H, linear or branched C₁- to C₇-alkyls, C₆- to C₉-alkylaryls or C₁- to C₇-acyl radicals, q is a number from 3 to 4, n and m are each a number from 1 to 20.

22. The process according to claim 1, wherein the surfactant and the blowing agent are added together to the monomer solution.

23. A water-absorbing polymer obtainable according to claim 1.

24. A composite including a water-absorbing polymer according to claim 1.

25. (canceled)

26. A composite obtainable by a process according to claim 23.

27. (canceled)

28. (canceled)
